(19) United States
(12) Patent Application Publication
(10) Pub. No.: US 2001/0032063 A1
(43) Pub. Date: Oct. 18, 2001

(54) Method and device for creating a model for a logistics process

(76) Inventors: Johannes Nardi, Amberg (DE); Guenter Sauer, Feucht (DE); Thomas Carl, Lichtenfels (DE); Markus Fasel, Ansbach (DE); Oswald Utz, Brunn (DE); Bernd Franke, Nuernberg (DE); Michael Schlez, Nuernberg (DE)

Correspondence Address: KENYON & KENYON, ONE BROADWAY, NEW YORK, NY, 10004, US

(21) Appl. No.: 09/731,257

(22) Filed: Dec. 6, 2000

(30) Foreign Application Priority Data
Dec. 7, 1999 (DE) 199 59 050.8

(51) Int. Cl. G06F 17/10

(52) U.S. Cl. 703/2

(57) ABSTRACT

In a method and a device for creating a model for a logistic process, the model including a plurality of process model units a plurality of process model units is created by selecting at least 50% of the plurality of process model units from a library of predetermined process model units. A relationship is established between at least two of the plurality of process model units.

### FIELD OF THE INVENTION

The present invention relates to a method for creating a model for a logistics process such as a part of a transportation operation, a storage operation, a carrier service operation and a postal service operation.

### SUMMARY OF THE INVENTION

An object of the present invention is to improve creating a model for a logistic process, and improve generating a set of instructions operating a logistic process.

It is a further object of the present invention to improve instructions for operating a logistic process.

The present invention provides a method for creating a model for a logistic process, the model including a plurality of process model units, the method comprising the steps of:

creating a plurality of process model units by selecting at least 50% of the plurality of process model units from a library of predetermined process model units; and

establishing a relationship between at least two of the plurality of process model units. This way a model for a logistics process may be created very efficiently. Furthermore, instructions, e. g., for running on a computer, have a higher quality standard in terms of computing efficiency and reliability if based on such a model.

In an embodiment of the method according to the present invention the creating the plurality of process model units is performed by selecting at least 90% of the plurality of process model units from a library of predetermined process model units. This way a model for a logistics process may be created even more efficiently. Furthermore, instructions, e. g., for running on a computer, have a even higher quality standard in terms of computing efficiency and reliability if based on such a model.

In another embodiment of the method according to the present invention the logistic process is at least a part of a transportation operation, a storage operation, a carrier service operation and/or a postal service operation.

In another embodiment of the method according to the present invention at least one of the plurality of process model units is adapted to the logistic process.

In another embodiment of the method according to the present invention the adapting of the at least one of the process model units to the logistics process includes the steps of:

opening a specification window by selecting a respective process model unit with a computer input device; and

entering data into the specification window.

In another embodiment of the method according to the present invention the selecting of the at least 50% of the plurality of process model units from a library of predetermined process model units includes the steps of:

selecting a respective process model unit in a data base window, the data base window revealing a content of the library of predetermined process model units; and

dragging the respective process model unit from the data base window into a process model window.

In another embodiment of the method according to the present invention the method further comprises the step of collecting data about the logistic process using a checklist, the checklist being based on the library of predetermined process model units.

The present invention also provides a method for creating a model for a logistic process, the model including a plurality of process model units, the method comprising the steps of:

collecting data about the logistic process using a checklist, the checklist being based on a library of predetermined process model units;

creating a plurality of process model units by selecting predetermined process model units from the library of predetermined process model units; and

establishing a relationship between at least two of the plurality of process model units.

In an embodiment of the method according to the present invention the logistic process is at least a part of at least one of a transportation operation, a storage operation, a carrier service operation and postal service operation.

In an another embodiment of the method according to the present invention the method further comprises the step of adapting at least one of the plurality of process model units to the logistic process.

The present invention also provides a method for generating a set of instructions for operating a logistic process, the method comprising the steps of:

creating a model for the logistic process, the model including a plurality of process model units, the creating a model including the steps of:

creating the plurality of process model units by selecting at least 50% of the plurality of process model units from a library of predetermined process model units; and

establishing a relationship between at least two of the plurality of process model units; and

generating the set of instructions from the model.

In an embodiment of the method according to the present invention the creating the plurality of process model units is performed by selecting at least 90% of the plurality of process model units from the library of predetermined process model units.

In another embodiment of the method according to the present invention the logistic process is at least a part of at least one of a transportation operation, a storage operation, a carrier service operation and a postal service operation.

In another embodiment of the method according to the present invention the method further comprises the step of adapting at least one of the plurality of process model units to the logistic process.

The present invention also provides a method for generating a set of instructions for operating a logistic process, the method comprising the steps of:

creating a model for the logistic process, the model including a plurality of process model units, the creating a model including the steps of:

collecting data about the logistic process using a checklist, wherein the checklist is based on a library of predetermined process model units;

creating the plurality of process model units by selecting predetermined process model units from the library of predetermined process model units; and

establishing a relationship between at least two of the plurality of process model units; and

generating the set of instructions from the model.

In an embodiment of the method according to the present invention the logistic process is at least a part of at least one of a transportation operation, a storage operation, a carrier service operation and a postal service operation.

In an another embodiment of the method according to the present invention the method further comprises the step of adapting at least one of the plurality of process model units to the logistic process.

The present invention also provides a computing arrangement for creating a model for a logistic process, the model including a plurality of process model units, the computing arrangement comprising a library of predetermined process model units for creating the model, at least 50% of the plurality of process model units being selectable from the library of predetermined process model units.

In an embodiment of the computing arrangement according to the present invention at least 90% of the plurality of process model units being selectable from the library of predetermined process model units.

In an embodiment of the computing arrangement according to the present invention the logistic process is at least a part of at least one of a transportation operation, a storage operation, a carrier service operation and a postal service operation.

In an embodiment of the computing arrangement according to the present invention the computing arrangement further comprises an output device for adapting at least one of the plurality of process model units to the logistic process.

In another embodiment of the computing arrangement according to the present invention the computing arrangement further comprises a checklist generator for generating a checklist based on the library of predetermined process model units, the checklist being usable for collecting data about the logistic process.

The present invention also provides a computing arrangement for creating a model for a logistic process, the model including a plurality of process model units, the computing arrangement comprising

a library of predetermined process model units for creating the model, process models units being selectable from the library of predetermined process model units; and

a check list generator for generating a checklist for collecting data used for creating the process model from the library of predetermined process model units.

In an embodiment of the computing arrangement according to the present invention the logistic process is at least a part of at least one of a transportation operation, a storage operation, a carrier service operation and a postal service operation.

In another embodiment of the computing arrangement according to the present invention the computing arrangement further comprises an output device for adapting at least one of the plurality of process model units to the logistic process.

The present invention also provides an article comprising a storage medium, the storage medium having a set of instructions, the set of instructions being capable of being executed by at least one processor to implement a method for operating a logistic process, the set of instructions being created by a method comprising the steps of:

creating a model for the logistic process, the model including a plurality of process model units, the creating a model including the steps of:

creating the plurality of process model units by selecting at least 50% of the plurality of process model units from a library of predetermined process model units; and

establishing a relationship between at least two of the plurality of process model units; and

generating the set of instructions from the model.

In an embodiment of the article according to the present invention the creating the plurality of process model units is performed by selecting at least 90% of the plurality of process model units from the library of predetermined process model units.

In an embodiment of the article according to the present invention the logistic process is at least a part of at least one of a transportation operation, a storage operation, a carrier service operation and a postal service operation.

In an another embodiment of the article according to the present invention the method for creating the set of instructions further comprises the step of adapting at least one of the plurality of process model units to the logistic process.

In an another embodiment of the article according to the present invention the method for creating the set of instructions further comprises the step of collecting data about the logistic process using a checklist, the checklist being based on the library of predetermined process model units.

The present invention also provides an article comprising a storage medium, the storage medium having a set of instructions, the set of instructions being capable of being executed by at least one processor to implement a method for operating a logistic process, the set of instructions being created by a method for generating the set of instructions for operating a logistic process comprising the steps of:

creating a model for the logistic process, the model including a plurality of process model units, the creating a model including the steps of:

collecting data about the logistic process using a checklist, wherein the checklist is based on a library of predetermined process model units;

creating the plurality of process model units by selecting predetermined process model units of the plurality of process model units from the library of predetermined process model units; and

establishing a relationship between at least two of the plurality of process model units; and

generating the set of instructions from the model.

In an embodiment of the article according to the present invention the logistic process is at least a part of at least one of a transportation operation, a storage operation, a carrier service operation and a postal service operation.

In an another embodiment of the article according to the present invention the method for creating the set of instructions further comprises the step of adapting at least one of the plurality of process model units to the logistic process.

### BRIEF DESCRIPTION OF THE DRAWINGS

The present invention is described in further detail below with reference to the drawings, in which:

FIG. 1 shows a schematic block diagram of a methodical software supported development of program code for operating a logistic process;

FIG. 2 shows a computing arrangement for consulting purposes and for developing process models or program code for operating a logistic process;

FIG. 3 shows a data acquisition window being displayed by a device according to FIG. 2 implementing an electronic checklist;

FIG. 4 shows a data base window, a process window, and a specification window displayed by a device according to FIG. 2; and

FIG. 5 shows a flow-chart of method for creating a process model.

### DETAILED DESCRIPTION

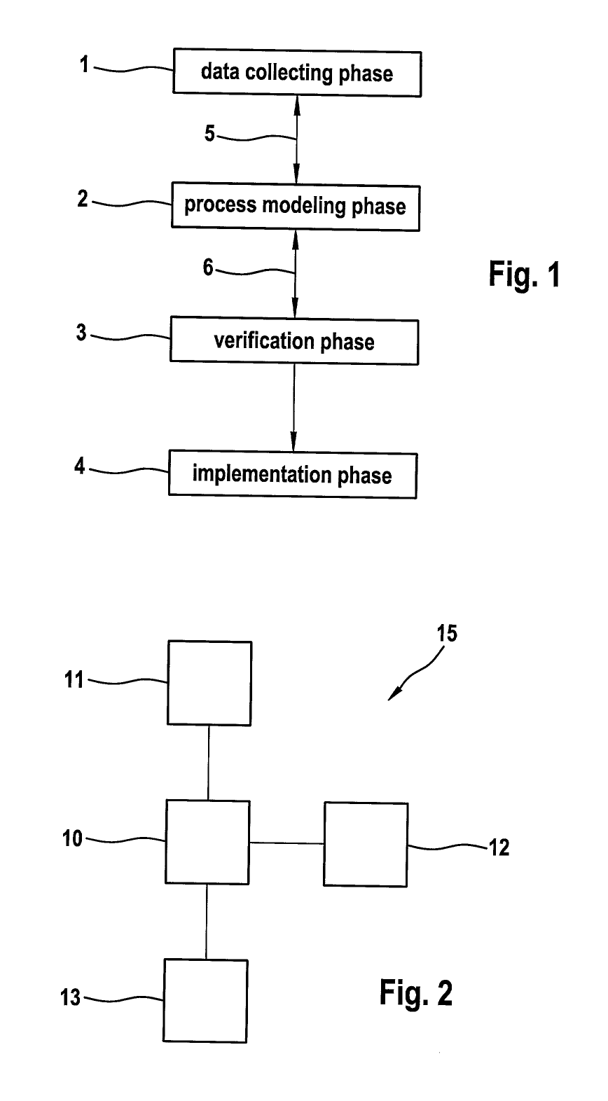

FIG. 1 shows a schematic block diagram of a methodical software supported development of program code, i. e., set of instructions, for operating a logistic process. In the current embodiment of a methodical software supported development of a set of instructions comprises four phases. In a data collecting phase 1 data are collected, which are used for modeling the process for which the set of instructions is to be developed or for which a process model is to be created. Such a process can be a transportation operation, a storage operation are a carrier service operation or a postal service operation or a part of such an operation.

The data collecting phase 1 is followed by a process modeling phase 2. In this phase a model of the logistic process is created for which data were collected in the data collecting phase. During the process modeling phase 2 it might be necessary to collect further data. This is indicated by the double headed arrow 5 between the data collecting phase 1 and the process modeling phase 2.

The process modeling phase 2 is followed by a verification phase 3 in which the process model created in the process modeling phase 2 is compared to a reference model modeling a similar logistic process. During the verification phase 3 simulation of the model may also be carried out. Further verification matters may be carried out as well. During the verification phase 3 some remodeling of the model might be necessary. This is indicated by the double headed arrow 6 between the process modeling phase 2 and the verification phase 3.

The verification phase 3 is followed by an implementation phase 4 generating a set of instructions in particular a program running on a computer, from the process model.

FIG. 2 shows a computing arrangement for at least supporting the data collection phase 1 and the process modeling phase 2. The computing arrangement 15 comprises a processing arrangement 10 such as a computer, an output device 11, such as a display or a computer monitor, and an input device 12 such as a computer mouse. The computing arrangement 15 further comprises a library 13 of process model units. The processing arrangement 10 may act as a check-list generator for generating an electronic check-list based on the library 13 of process model units. The electronic check-list may be displayed on the output device 11, e. g., in terms of data acquisition window.

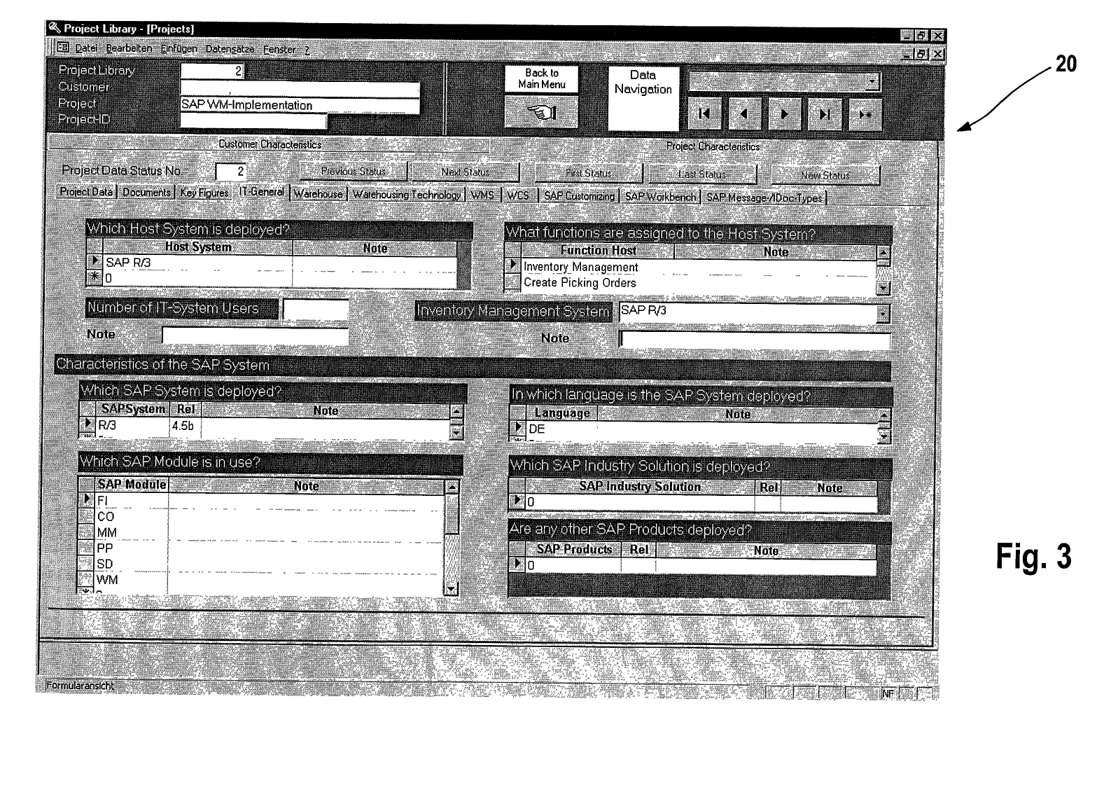

FIG. 3 shows such a data acquisition an example of window 20 implementing the electronic checklist.

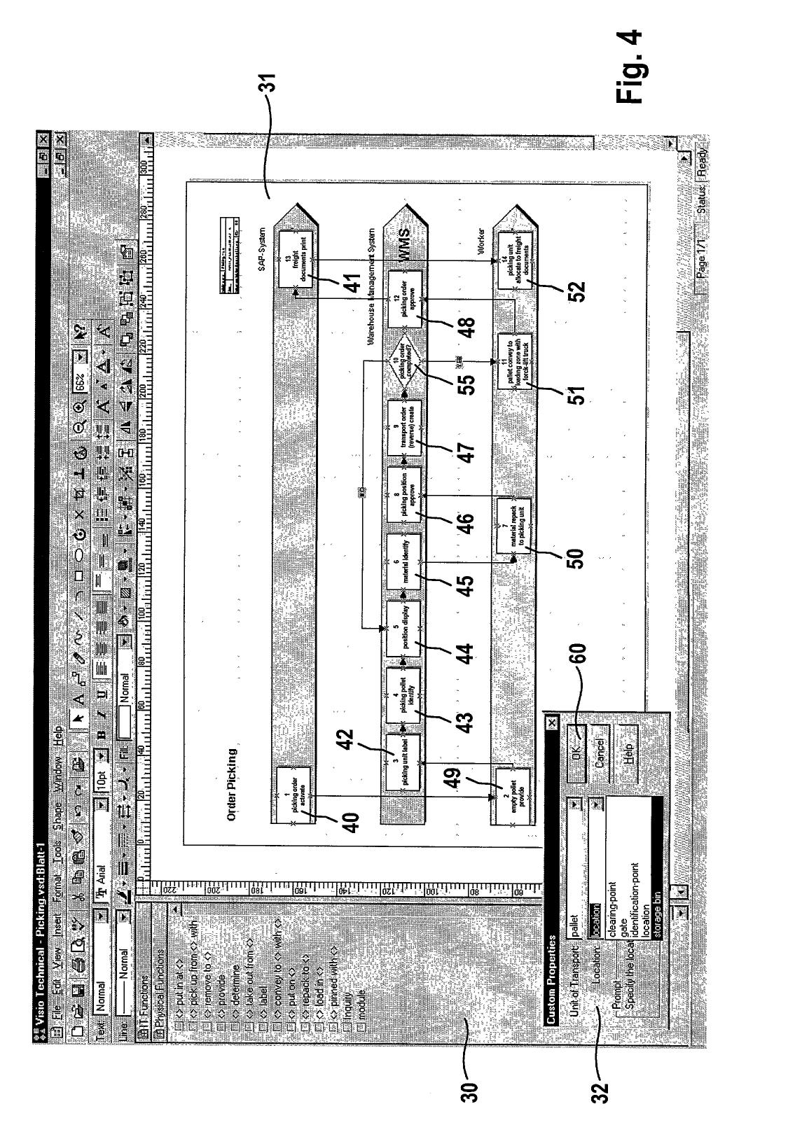

FIG. 4 shows a data base window 30, a process window 3 1, and a specification window 32 displayed by a device according to FIG. 2. In the data base window 30 the elements of the library of process model units are displayed. In the current embodiment these elements comprise, e.g., the functions <>put in at<>, <>pick up from <>with<>, <>remove to<>, <>provide, <>determine, <>take out from<>, <>label, <>convey to<>with<>, <>put on<>, <>repack to<>, <>load in<>, and <>Pinned with<>. In the process window 31 a model of a logistic process may be generated comprising process model units 40, 41, 42, 43, 44, 45, 46, 47, 48, 49, 50, 51, and 52 as well as a decision block 55. The process model units 40, 41, 42, 43, 44, 45, 46, 47, 48, 49, 50, 51, and 52 are generated by dragging a respective function from the data base window 30 into the process window 31. To specify a process model unit a specification window 32 may be opened by selecting the particular process model unit via a double clicking with a computer mouse. The specification window 32 allows inputting specific data by offering a selection of these specific data. The location shows in the specification window 32 of the embodiment of FIG. 4 for example can be a clearing point, an identification point, a storage bin, or a location to be further specified. By clicking an o. k.-button 60 in the specification window 32, the window may be closed. The process model unit 50, e.g., may be generated by dragging the function <>repack to<>from the data base window 30 and specifying “material” and “picking unit” to obtain the process model unit 50 “material repack to picking unit” to obtain a process model the process model units may be connected.

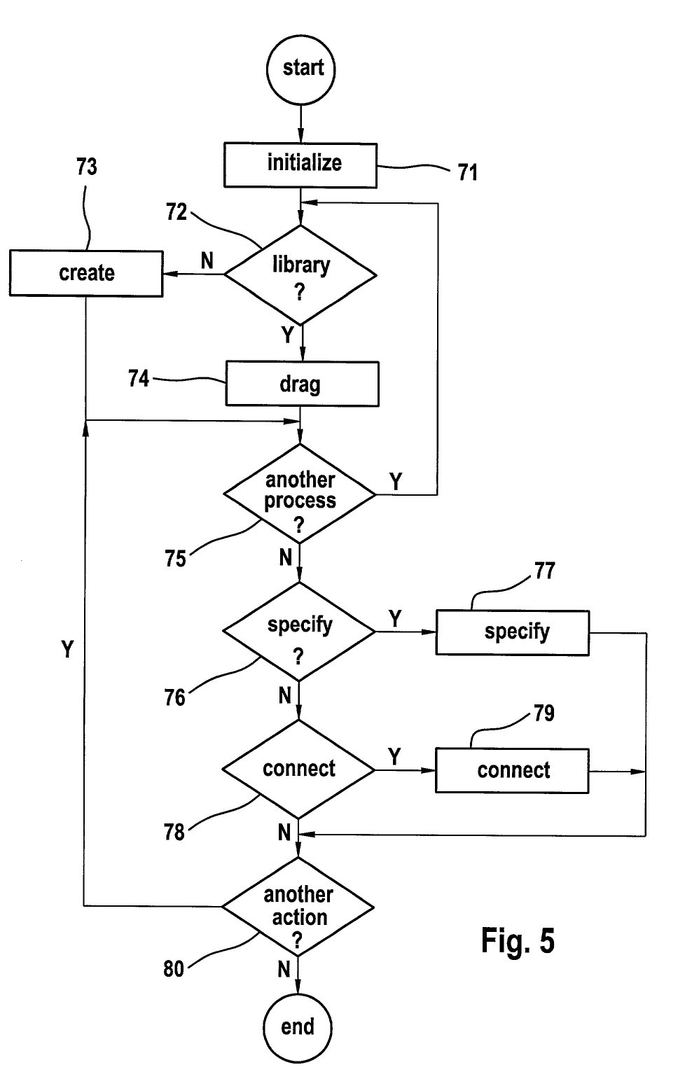

FIG. 5 shows a method for creating a process model in the form of a flowchart. The method starts with some initialization represented by an initialization step 71. The initialization step 71 is followed by a decision block 72 for deciding whether the particular process model unit to be created can be taken from the library of process model units or not. If the specific process model unit may not be taken from the library of process model units, the process model unit is created in a step 73. If, however, the specific process model unit may be taken from the library of process model units, the process model unit is dragged in a step 74 from the data base window 30 into the process window 31. Steps 73 and 74 are followed by another decision block 75 for deciding whether another process model unit shall be added to the process window 31. If another process model unit is to be added to the process window 31 the decision block 75 is followed by a decision block 72. If not, the decision block 75 is followed by a decision block 76 for deciding whether the specific process model unit needs to be specified. If the specific process model unit needs to be specified, decision block 76 is followed by a step 77 specifying the specific process model unit by opening a specification window 32 and inputting the required data. If the specification of the specific process model unit is neither desired nor necessary, the decision block 76 is followed by a decision block 78 for deciding whether process model units shall be connected. If process model units shall be connected, the decision block 78 is followed by a step 79 for connecting process model units. If connecting process model units is neither necessary nor desired, the decision block 78 is followed by a decision block 80 for deciding whether another action is required or desired or whether the flow may be terminated. Steps 77 and 79 are also followed by the decision block 80. If another action is desired or necessary, the decision block 80 is followed by the decision block 75.

What is claimed is:

1. A method for creating a model for a logistic process, the model including a plurality of process model units, the method comprising the steps of:
creating a plurality of process model units by selecting at least 50% of the plurality of process model units from a library of predetermined process model units; and
establishing a relationship between at least two of the plurality of process model units.

2. The method as recited in claim 1, wherein the creating the plurality of process model units is performed by selecting at least 90% of the plurality of process model units from a library of predetermined process model units.

3. The method as recited in claim 1, wherein the logistic process is at least a part of at least one of a transportation operation, a storage operation, a carrier service operation and a postal service operation.

4. The method as recited in claim 1 further comprising the step of adapting at least one of the plurality of process model units to the logistic process.

5. The method as recited in claim 4, wherein the adapting the at least one of the process model units includes the steps of:
opening a specification window by selecting a respective process model unit with a computer input device; and
entering data into the specification window.

6. The method as recited in claim 1 wherein selecting of the at least 50% of the plurality of process model units from a library of predetermined process model units includes the steps of:
selecting a respective process model unit in a data base window, the data base window revealing a content of the library of predetermined process model units; and
dragging the respective process model unit from the data base window into a process model window.

7. The method as recited in claim 1 further comprising the step of collecting data about the logistic process using a checklist, the checklist being based on the library of predetermined process model units.

8. A method for creating a model for a logistic process, the model including a plurality of process model units, the method comprising the steps of:
collecting data about the logistic process using a checklist, the checklist being based on a library of predetermined process model units;
creating a plurality of process model units by selecting predetermined process model units from the library of predetermined process model units; and
establishing a relationship between at least two of the plurality of process model units.

9. The method as recited in claim 8 wherein the logistic process is at least a part of at least one of a transportation operation, a storage operation, a carrier service operation and postal service operation.

10. The method as recited in claim 8 further comprising the step of adapting at least one of the plurality of process model units to the logistic process.

11. A method for generating a set of instructions for operating a logistic process, the method comprising the steps of:
creating a model for the logistic process, the model including a plurality of process model units, the creating a model including the steps of:
creating the plurality of process model units by selecting at least 50% of the plurality of process model units from a library of predetermined process model units; and
establishing a relationship between at least two of the plurality of process model units; and
generating the set of instructions from the model.

12. The method as recited in claim 11 wherein the creating the plurality of process model units is performed by selecting at least 90% of the plurality of process model units from the library of predetermined process model units.

13. The method as recited in claim 11 wherein the logistic process is at least a part of at least one of a transportation operation, a storage operation, a carrier service operation and a postal service operation.

14. The method as recited in claim 11 further comprising the step of adapting at least one of the plurality of process model units to the logistic process.

15. A method for generating a set of instructions for operating a logistic process, the method comprising the steps of:
creating a model for the logistic process, the model including a plurality of process model units, the creating a model including the steps of:
collecting data about the logistic process using a checklist, wherein the checklist is based on a library of predetermined process model units;
creating the plurality of process model units by selecting predetermined process model units from the library of predetermined process model units; and
establishing a relationship between at least two of the plurality of process model units; and
generating the set of instructions from the model.

16. The method as recited in claim 15 wherein the logistic process is at least a part of at least one of a transportation operation, a storage operation, a carrier service operation and a postal service operation.

17. The method as recited in claim 15 further comprising the step of adapting at least one of the plurality of process model units to the logistic process.

18. A computing arrangement for creating a model for a logistic process, the model including a plurality of process model units, the computing arrangement comprising a library of predetermined process model units for creating the model, at least 50% of the plurality of process model units being selectable from the library of predetermined process model units.

19. The computing arrangement as recited in claim 18 wherein at least 90% of the plurality of process model units being selectable from the library of predetermined process model units.

20. The computing arrangement as recited in claim 18 wherein the logistic process is at least a part of at least one of a transportation operation, a storage operation, a carrier service operation and a postal service operation.

21. The computing arrangement as recited in claim 18 further comprising an output device for adapting at least one of the plurality of process model units to the logistic process.

22. The computing arrangement as recited in claim 18 further comprising a checklist generator for generating a checklist based on the library of predetermined process model units, the checklist being usable for collecting data about the logistic process.

23. A computing arrangement for creating a model for a logistic process, the model including a plurality of process model units, the computing arrangement comprising
a library of predetermined process model units for creating the model, process models units being selectable from the library of predetermined process model units; and
a check list generator for generating a checklist for collecting data used for creating the process model from the library of predetermined process model units.

24. The computing arrangement as recited in claim 23 wherein the logistic process is at least a part of at least one of a transportation operation, a storage operation, a carrier service operation and a postal service operation.

25. The computing arrangement as recited in claim 23 further comprising an output device for adapting at least one of the plurality of process model units to the logistic process.

26. An article comprising a storage medium, the storage medium having a set of instructions, the set of instructions being capable of being executed by at least one processor to implement a method for operating a logistic process, the set of instructions being created by a method comprising the steps of:
creating a model for the logistic process, the model including a plurality of process model units, the creating a model including the steps of:
creating the plurality of process model units by selecting at least 50% of the plurality of process model units from a library of predetermined process model units; and
establishing a relationship between at least two of the plurality of process model units; and
generating the set of instructions from the model.

27. The article as recited in claim 26 wherein the creating the plurality of process model units is performed by selecting at least 90% of the plurality of process model units from the library of predetermined process model units.

28. The article as recited in claim 26 wherein the logistic process is at least a part of at least one of a transportation operation, a storage operation, a carrier service operation and a postal service operation.

29. The article as recited in claim 26 wherein the method for creating the set of instructions further comprises the step of adapting at least one of the plurality of process model units to the logistic process.

30. The article as recited in claim 26 wherein the method for creating the set of instructions further comprises the step of collecting data about the logistic process using a checklist, the checklist being based on the library of predetermined process model units.

31. An article comprising a storage medium, the storage medium having a set of instructions, the set of instructions being capable of being executed by at least one processor to implement a method for operating a logistic process, the set of instructions being created by a method for generating the set of instructions for operating a logistic process comprising the steps of:
creating a model for the logistic process, the model including a plurality of process model units, the creating a model including the steps of:
collecting data about the logistic process using a checklist, wherein the checklist is based on a library of predetermined process model units;
creating the plurality of process model units by selecting predetermined process model units of the plurality of process model units from the library of predetermined process model units; and
establishing a relationship between at least two of the plurality of process model units; and
generating the set of instructions from the model.

32. The article as recited in claim 26 wherein the logistic process is at least a part of at least one of a transportation operation, a storage operation, a carrier service operation and a postal service operation.

33. The article as recited in claim 30 wherein the method for creating the set of instructions further comprises the step of adapting at least one of the plurality of process model units to the logistic process.
